(19) United States
(12) Patent Application Publication
(10) Pub. No.: US 2026/0267211 A1
(43) Pub. Date: Sep. 10, 2026

(54) LASER PROJECTION SYSTEMS AND METHODS

(71) Applicant: Universal City Studios LLC, Universal City, CA (US)

(72) Inventors: Bryan Zebleckes, Orlando, FL (US); Conor Triplett, Orlando, FL (US); Anthony J. Aguilar, Windermere, FL (US); Mary Elizabeth Clark, Portland, OR (US); Michael King, Orlando, FL (US); Stefan David Price, Winter Garden, FL (US)

(21) Appl. No.: 19/558,890

(22) Filed: Mar. 6, 2026

Related U.S. Application Data
(60) Provisional application No. 63/995,664, filed on Mar. 3, 2026.
(60) Provisional application No. 63/768,016, filed on Mar. 6, 2025.

(51) Int. Cl. G03B 21/60; B24C 1/00; G03B 21/14; G03B 21/20

(52) U.S. Cl. CPC G03B 21/60; B24C 1/00; G03B 21/147; G03B 21/2033

(57) ABSTRACT

A laser projection system includes a laser projector configured to project an image. The laser projection system includes a display with tempered glass, wherein the tempered glass includes a first surface that faces toward the laser projector and a second surface that faces toward a guest area, and the first surface and the second surface includes a surface treatment that enables a guest in the guest area to view the image projected onto on the first surface through the second surface without a banding effect.

### CROSS-REFERENCE TO RELATED APPLICATIONS

This application claims priority to and the benefit of U.S. Provisional Application No. 63/768,016, entitled “LASER PROJECTION SYSTEMS AND METHODS” and filed Mar. 6, 2025, and also claims priority to and the benefit of U.S. Provisional Application No. 63/995,664, entitled “LASER PROJECTION SYSTEMS AND METHODS” and filed Mar. 3, 2026, each of which is incorporated by reference in its entirety herein for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks and other entertainment venues often contain attractions that use images (e.g., video and/or still images) to entertain guests. For example, the attractions may include themed environments established using display devices that display media content (e.g., video, still images, text, motion graphics, or a combination thereof). For some attractions, it may be desirable to display media content with special visual effects to create a realistic and/or an immersive viewing experience for the guests. However, this may be challenging due to considerations relating to cost, space, equipment availability, and/or viewing area environment, for example.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a laser projection system includes a laser projector configured to project an image. The laser projection system includes a display with tempered glass, wherein the tempered glass includes a first surface that faces toward the laser projector and a second surface that faces toward a guest area, and the first surface and the second surface includes a surface treatment that enables a guest in the guest area to view the image projected onto on the first surface through the second surface without a banding effect.

In an embodiment, a method of manufacturing a laser projection system includes applying a surface treatment to a first surface and a second surface of a tempered glass to form a treated tempered glass, applying a coating to the treated tempered glass to form a coated treated tempered glass, and positioning the coated treated tempered glass between a laser projector and a guest area to enable a guest in the guest area to view an image projected by the laser projector onto the coated treated tempered glass without a banding effect.

In an embodiment, a laser projection system includes a wall assembly with a first support structure and a second support structure separated from one another by a gap. The laser projection system also includes a laser projector supported on the first support structure and configured to project an image onto a display of a display assembly. The laser projection system further includes the display assembly supported on the second support structure. The display assembly includes the display with tempered glass, wherein the tempered glass includes a first surface that faces toward the laser projector and a second surface that faces toward a guest area, the first surface and the second surface include a surface treatment, and at least one of the first surface or the second surface includes a coating. The display assembly also includes a frame surrounding the display, wherein at least a portion of the frame is positioned in an opening that extends through the second support structure.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a laser projection system that includes a laser projector and a display assembly, in accordance with an embodiment of the present disclosure;

FIG. 2 illustrates the laser projection system of FIG. 1, including a side view of a portion of the display assembly, in accordance with an embodiment of the present disclosure;

FIG. 3 illustrates the laser projection system of FIG. 1, including a cross-sectional side view of a support structure and the display assembly mounted to the support structure, in accordance with an embodiment of the present disclosure;

FIG. 4 is a front perspective view of the laser projection system of FIG. 1, including the support structure and multiple display assemblies mounted to the support structure, in accordance with an embodiment of the present disclosure;

FIG. 5 is a flow diagram of a method of manufacturing a laser projection system, such as the laser projection system of FIGS. 1-4, in accordance with an embodiment of the present disclosure;

FIG. 6 illustrates a laser projection system including a display assembly with a curved display portion, in accordance with an embodiment of the present disclosure; and

FIG. 7 illustrates an example of undesirable visual effects, such as a banding effect, that may occur without specific techniques disclosed herein.

### DETAILED DESCRIPTION

When introducing elements of various embodiments of the present disclosure, the articles “a,” “an,” and “the” are intended to mean that there are one or more of the elements. The terms “comprising,” “including,” “having,” and “based on” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates generally to laser projection systems and methods. In an embodiment, the laser projection systems and methods may be used to generate displays for an attraction in an amusement park or other entertainment venue. For example, the laser projection systems and methods may be used to display images (e.g., video and/or still images) to guests in a guest area, such as guests carried by a ride vehicle through the guest area, guests that walk along a path (e.g., in a queue) through the guest area, guests seated in the guest area of a theatre, and so forth.

The laser projection systems and methods advantageously enable use of one or more laser projectors, which may have a relatively small size (e.g., as compared to other types of projectors, such as liquid crystal display (LCD) projectors, digital light processing DLP) projectors, light emitting diode (LED) projectors). In a context of the amusement park or other entertainment venue, the relatively small size may be particularly important and useful, as space may be limited and/or multiple projectors may be utilized within a given space. Indeed, the relatively small size may enable new, creative arrangements of entertainment environments. Additionally, in the context of the amusement park or other entertainment venue, it may be desirable to use durable materials, such as a durable version of a particular material, such as a tempered glass. The tempered glass in particular may also support and/or enable certain themes, such as by providing an antique and/or worn appearance. The tempered glass may include glass that is made by heating an initial glass (e.g., common, normal glass) near its softening point (e.g., near or above 600 degrees Celsius) and then rapidly cooling with jets of air (e.g., quenching) to thereby create a strong surface compression and internal tension, and further resulting in making the tempered glass that is stronger (e.g., four to five times stronger) than the initial glass. Further, the tempered glass may be less likely to shatter or break as compared to the initial glass, but if it does break then it typically breaks into blunt, granular pieces instead of sharp shards as may occur with the initial glass.

Thus, present embodiments use one or more laser projectors to project images onto tempered glass to provide a compact laser projection system, while also providing a durable projection surface (e.g., display assembly that includes tempered glass). However, without specific techniques disclosed herein (e.g., specific surface treatments and/or coatings; specific arrangement of the one or more laser projectors and the tempered glass), projection of the images by the one or more laser projectors onto the display assembly that includes the tempered glass may result in undesirable visual effects. For example, the undesirable visual effects may include undesirable and/or unintended colors, such as bands of color (e.g., a yellow band, a red band, a blue band, a green band) that extend across the display and that are visually perceptible from a guest area (e.g., an area from which a guest may view the tempered glass). In such cases, the undesirable visual effects may be due to coherent light output by the one or more laser projectors and characteristics of the tempered glass (e.g., highly reflective; surface stress; thickness; imperfections, including surface imperfections, due to heating and cooling during tempering process), and more specifically to interactions between the coherent light output by the one or more laser projectors and the tempered glass. To facilitate discussion, the undesirable visual effects are referred to herein as a “banding effect” and refer generally to bands or sections of colors (e.g., visible spectrum; visible to human eye). Present embodiments block this banding effect (e.g., prevent, eliminate, and/or reduce to be imperceptible to the human eye), and thus, present the images for visualization from the guest area in a more clear, realistic manner. As such, present embodiments provide an immersive entertainment experience.

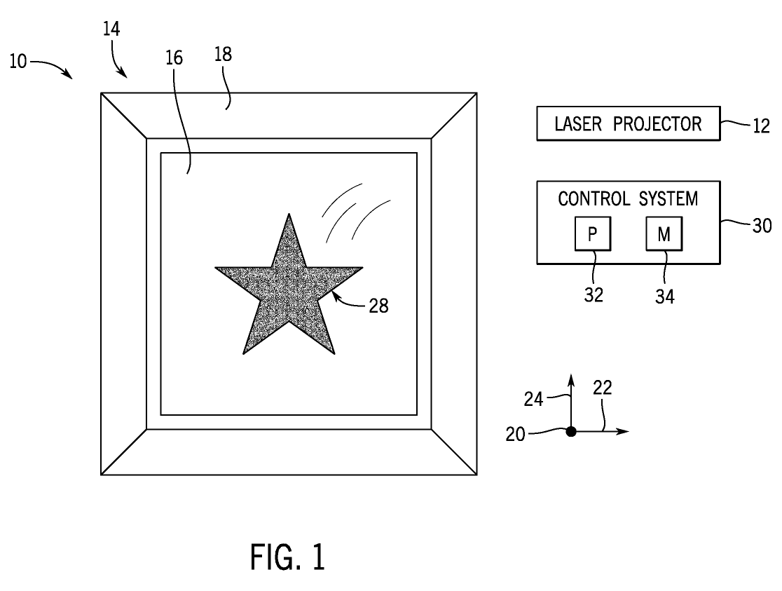

FIG. 1 illustrates a laser projection system 10 that includes a laser projector 12 and a display assembly 14, in accordance with an embodiment of the present disclosure. The display assembly 14 may include a display portion 16 (e.g., display) and a frame portion 18 (e.g., frame). To facilitate discussion, the laser projection system 10 and components of the laser projection system 10 may be described with reference to an axial axis 20, a lateral axis 22, and/or a vertical axis 24.

The display portion 16 may include a tempered glass (e.g., a layer or sheet of tempered glass). Additionally, the display portion 16 may include a surface treatment to the tempered glass. As an example, the surface treatment may include an abrasive blasting treatment (e.g., a sand blasting treatment) applied to the tempered glass. As an example, the surface treatment may include a film applied (e.g., adhered) to the tempered glass. In an embodiment, the surface treatment to the tempered glass may include the surface treatment to a first surface of the tempered glass and/or a second surface of the tempered glass, wherein the first surface faces toward the laser projector and the second surface faces toward a guest area (e.g., a guest viewing area). The surface treatment may affect, such as clean and/or smooth and/or texturize, the first surface of the tempered glass and/or the second surface of the tempered glass. For example, the surface treatment may change a surface roughness measure of the tempered glass. For example, the surface treatment may affect (e.g., change, diffuse) light pathways through the tempered glass. To facilitate discussion, after the tempered glass is subjected to the surface treatment, the tempered glass may be referred to herein as a “treated tempered glass.”

In an embodiment, a coating may be applied to the treated tempered glass. In an embodiment, the coating may be applied to the second surface of the treated tempered glass. The coating may be a projection paint, a projection film, or any other type of coating that enables display of images. The coating may be a rear projection coating that enables the images to pass through the coating and to be visible from the guest area. To facilitate discussion, after application of the coating to the treated tempered glass, the tempered glass may be referred to herein as a “coated treated tempered glass.”

The display portion 16 may have any suitable shape (e.g., outline; geometry; when viewed from the guest area), such as a square shape, rectangular shape, polygonal shape, circular shape, oval shape, rounded shape, and so forth. That is, the tempered glass may be cut and/or shaped into any suitable shape, and then the surface treatment and/or the coating may be applied to the tempered glass with the suitable shape.

When present, in an embodiment, the frame portion 18 peripherally surrounds the display portion 16. Additionally or alternatively, the frame portion 18 may be coupled (e.g., mounted, fastened, adhered) to the display portion 16, and further may serve to couple (e.g., mount, fasten, adhere) the display assembly 14 to a support structure, such as a wall. Thus, the frame portion 18 may be decorative (e.g., to add to a theme of the attraction) and/or provide utility (e.g., to support, protect, and/or couple the display assembly 14 to the support structure). Together, the display portion 16 and the frame portion 18 may provide the display assembly 14 that is structurally stable and durable, and as such, may withstand contact by guests in the guest area. For example, even if the display assembly 14 is not intended to be contacted by the guests in the guest area, at least some guests may still contact the display assembly 14 either due to interest and/or inadvertent touch. However, in an embodiment, the display assembly 14 may be intended to be contacted by the guests in the guest area, such as when the display assembly 14 is used as part of an interactive display system, for example.

The laser projector 12 may include one or more lasers (e.g., one laser light source per color, such as three laser light sources (red, green, blue) for full color projection). The laser projector 12 may include the one or more lasers and/or other optical components that enable the laser projector 12 to project beams of light (e.g., laser beams; coherent light). In particular, when the laser projector 12 projects the beams of light onto the display portion 16 of the display assembly 14, the beams of light create images (e.g., video) that are visible on the display portion 16 of the display assembly 14 from the guest area. As described herein, the display portion 16 may include the tempered glass, which may be the treated tempered glass or the coated treated tempered glass that enables the images to be visible on the display portion 16 of the display assembly 14 from the guest area without a banding effect. Further, the tempered glass, which may be the treated tempered glass or the coated treated tempered glass may also further the theme of the attraction, such as by providing an antique and/or worn appearance. While FIG. 1 includes a star shape 28 (e.g., a video of the star shape) as an example of the images that may be visible on the display portion 16 of the display assembly 14 from the guest area, it should be appreciated that the laser projection system 10 may be utilized to present any of a variety of images, including video and/or still images. Further, the images may include representations of animals, animation characters (e.g., movie or television characters), design graphics, text messages, or a combination thereof.

As shown in FIG. 1, the laser projection system 10 may also include a control system 30 (e.g., electronic control system) with a processor 32 (representative of one or more processors) and memory 34 (representative of one or more memories). The memory 34 may include volatile memory, such as random-access memory (RAM), and/or non-volatile memory, such as read-only memory (ROM), optical drives, hard disc drives, solid-state drives, or any other non-transitory computer-readable medium that includes instructions to operate the laser projector 12. The processor 32 may be configured to execute such instructions. For example, the processor 32 may include one or more application specific integrated circuits (ASICs), one or more field programmable gate arrays (FPGAs), one or more general-purpose processors, or any combination thereof.

While certain examples and processing configurations are described herein to facilitate discussion, it should be appreciated that the actions described herein may be distributed between multiple processors (e.g., as part of a processing system). For example, the processor 32 may include multiple processors that may operate together to carry out any suitable actions described herein (e.g., a first processor carries out first processing steps, a second processor carries out second process steps, and so forth). Accordingly, terms such as “controller,” “control system,” “computing system,” “processing system,” and/or “processing circuitry” as used herein may refer to any variation and/or configuration of one or more processors and/or one or more memories, that operate together in any suitable manner to carry out disclosed techniques. While the laser projection system 10 is shown to include one laser projector 12 and one display assembly 14 to facilitate discussion, it should be appreciated that the laser projection system 10 may include multiple laser projectors 12 and multiple display assemblies 14 (e.g., one laser projector 12 per display assembly 14, with one, two, three, four, five, six, seven, eight, or more laser projectors 12 and display assemblies 14 present in the attraction and/or controlled by the control system 30).

It should be appreciated that the control system 30 may instruct the laser projector 12 and/or one or more additional laser projectors 12 (e.g., of the multiple laser projectors 12) to project images based on various inputs and/or in various manners to provide visual effects to the guests in the guest area. For example, the control system 30 may instruct the laser projector 12 and/or the one or more additional laser projectors 12 to project images in coordination with a show (e.g., being played by other components as part of the attraction; such as other images output by one or more other projectors and/or displays, sounds output by one or more speakers, haptics output by one or more haptic devices), in coordination with one another (e.g., to coordinate presentation of images on multiple display assemblies 14 visible to the guests in the guest area; such as in sequence, simultaneously, or other manner), in coordination with movement of a ride vehicle (e.g., as the ride vehicle travels past the display assembly 14 and/or the multiple display assemblies 14), in response to a presence of one or more guests in the guest area (e.g., as detected by one or more sensors that monitor the guest area, such as by reading identifiers on objects carried (e.g., held or worn) by the guests in the guest area), or any combination thereof.

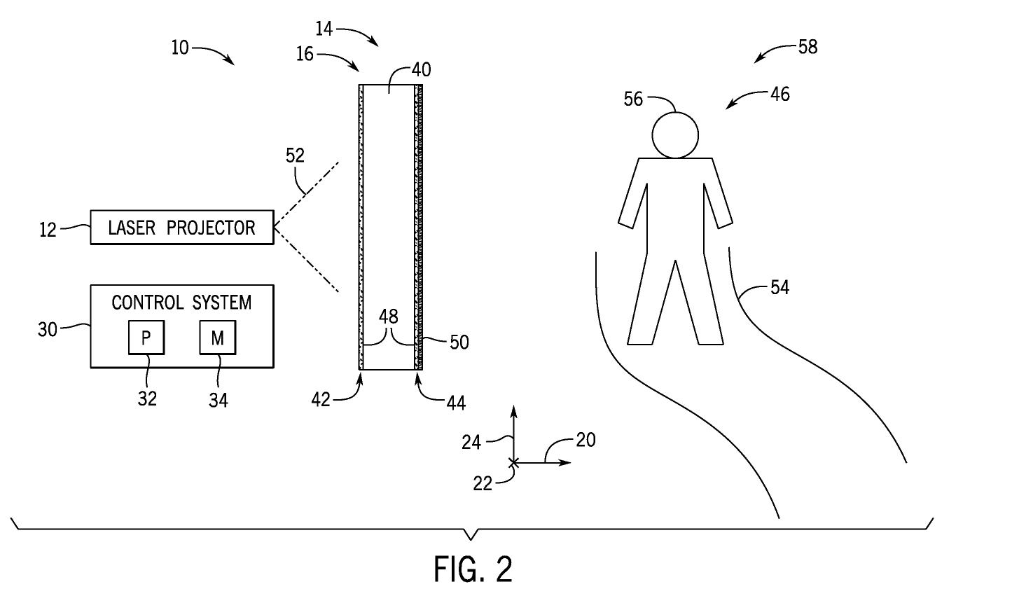

FIG. 2 illustrates the laser projection system 10 of FIG. 1, including a side view of a portion of the display assembly 14, in accordance with an embodiment of the present disclosure. As shown, the display portion 16 of the display assembly 14 may include a tempered glass 40 (e.g., a layer or sheet of tempered glass). Additionally, the display portion 16 may include a surface treatment to the tempered glass 40. As an example, the surface treatment may include an abrasive blasting treatment (e.g., a sand blasting treatment) applied to the tempered glass 40. As an example, the surface treatment may include a film applied (e.g., adhered) to the tempered glass 40. In an embodiment, the surface treatment to the tempered glass 40 may include the surface treatment to a first surface 42 of the tempered glass 40 and/or a second surface 44 of the tempered glass 40. As shown, the first surface 42 faces toward the laser projector 12 and the second surface 44 faces toward a guest area 46 (e.g., a guest viewing area). The first surface 42 and the second surface 44 may be on opposite sides (e.g., a first side, such as a laser-facing side, and a second side, such as a guest-facing side) of the tempered glass 40. The surface treatment is represented as surface treatment layers 48 in FIG. 2 to facilitate visualization and discussion of various features of the display portion 16 of the display assembly 14, but at least in the case of the abrasive blasting treatment, it should be appreciated that the surface treatment layers 48 may be integrated into and/or part of the tempered glass 40 (e.g., extend an axial distance from the first surface 42 and/or the second surface 44 into the tempered glass 40). As noted herein, together, the tempered glass 40 and the surface treatment layers 48 may be considered to form the treated tempered glass.

In an embodiment, a coating 50 (e.g., coating layer) may be applied to the treated tempered glass. In an embodiment, the coating 50 may be applied to the second surface 44 of the treated tempered glass. The coating 50 may be a projection paint, a projection film, or any other type of coating that enables display of images. The coating 50 may be a rear projection coating that enables the images to pass through the coating 50 and to be visible from the guest area 46. As noted herein, together, the tempered glass 40, the surface treatment layers 48, and the coating 50 may be considered to form the coated treated tempered glass. While the coating 50 is shown on the second surface 44, it should be appreciated that the coating 50 may additionally or alternatively be applied to the first surface 42 of the treated tempered glass (e.g., on the first surface 42 instead of the second surface 44; on both the first surface 42 and the second surface 44 as separate layers or coatings).

In operation, the control system 30 may instruct the laser projector 12 to project beams of light 52 onto the display portion 16 of the display assembly 14, and the beams of light 52 create images (e.g., video) that are visible on the display portion 16 of the display assembly 14 from the guest area 46. Advantageously, the display portion 16 may include the coated treated tempered glass that enables the images to be visible on the display portion 16 of the display assembly 14 from the guest area 46 without the banding effect. In an embodiment, the coated treated tempered glass may also provide a visual effect of the images appearing on the second surface 44 (e.g., the images appearing to be displayed on or present on the second surface 44; so as to appear to be proximate to the guest area 46, rather than recessed within the display portion 16 or distant from the guest area 46). Further, the coated treated tempered glass may also further the theme of the attraction, such as by providing the antique and/or worn appearance. As shown, the guest area 46 may include a path 54 along which a guest 56 may travel (e.g., walk). For example, the path 54 may be a designated area for the guest 56 and other guests to line up to form a queue to access a ride attraction, a dining experience, a show, and so forth. It should be appreciated that the guest area 46 may have any suitable form and may be in any suitable region of an entertainment venue 58. For example, a ride vehicle may carry one or more guests through the guest area to enable the one or more guests to view the images, one or more guests may be seated in seats of a theatre that forms the guest area of a theatre to enable the one or more guests to view the images, and so forth.

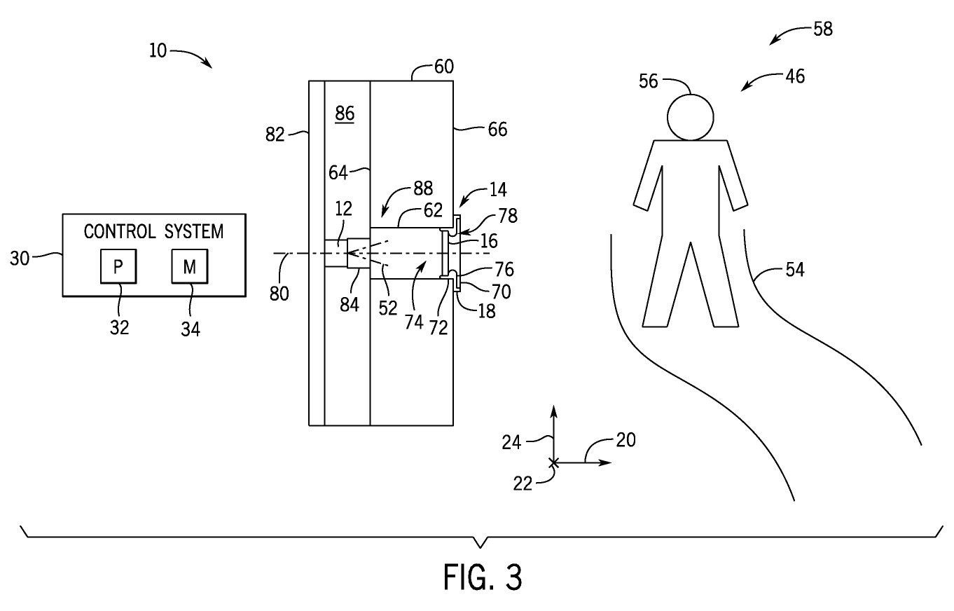

FIG. 3 illustrates the laser projection system 10, including a cross-sectional side view of a support structure 60 and the display assembly 14 mounted to the support structure 60, in accordance with an embodiment of the present disclosure. The support structure 60 may be a wall, such as a decorative and/or structural wall in the entertainment venue 58. An opening 62 (e.g., through hole; extending along the axial axis 20) may extend from a first support surface 64 to a second support surface 66 of the support structure 60. As shown, the first support surface 64 faces toward the laser projector 12 and the second support surface 66 faces toward the guest area 46. Further, the first support surface 64 and the second support surface 66 may be on opposite sides (e.g., a first side, such as a laser-facing side, and a second side, such as a guest-facing side) of the support structure 60.

The display assembly 14 may include the display portion 16 and the frame portion 18. As shown, the frame portion 18 may be coupled (e.g., mounted, fastened, adhered) to the display portion 16, and further may be coupled (e.g., mounted, fastened, adhered) to the support structure 60. In an embodiment, the frame portion 18 may include an frame structure 70 (e.g., with an inner edge and an outer edge with a round, circular, oval, elliptical, rectangular, triangular, or any other suitable shape from a perspective of the guest area 46, wherein the inner edge and the outer edge may have a same shape or different shapes; circular, round, non-circular, or non-round ring structure; circular, round, non-circular, or non-round annular structure) that peripherally surrounds the display portion 16 and is visible to the guest 56 in the guest area 46. For example, the frame structure 70 may appear to be a picture frame that peripherally surrounds the display portion 16. In an embodiment, the frame portion 18 may include a bracket 72 (e.g., frame-shaped or ring-shaped bracket) that contacts and couples to the support structure 60. For example, at least a portion of the bracket 72 (e.g., axially-extending ring) may contact and insert into the opening 62 of the support structure 60, and additionally one or more fasteners (e.g., threaded fasteners, such as bolts; adhesives) may extend between the bracket 72 and the support structure 60 to couple (e.g., mount, fasten, secure) the bracket 72 to the support structure 60. In an embodiment, the frame structure 70 and the bracket 72 may have a one-piece construction (e.g., molded and/or otherwise manufactured as one piece; integrally formed). However, it should be appreciated that the frame structure 70 and the bracket 72 may have a multi-piece construction and be coupled together.

As noted herein, the frame portion 18 may be coupled (e.g., mounted, fastened, adhered) to the display portion 16. For example, the frame portion 18 may receive and support the display portion 16. To accomplish this, in an embodiment, the display portion 16 may be inserted into and sit within the bracket 72 of the frame portion 18. That is, the display portion 16 may be inserted into a first side 74 of the bracket 72 and then sit within the bracket 72. In an embodiment, the frame portion 18 may include a lip 76 (e.g., frame-shaped or ring-shaped stop or lip), and thus, the display portion 16 may be inserted into the first side 74 of the bracket 72 until the display portion 16 contacts the lip 76, and then sit within the bracket 72. The lip 76 may block movement of the display portion 16 along the axial axis 20 toward the guest area 46 (e.g., the lip 76 may retain the display portion 16 within the opening 62). In an embodiment, the display portion 16 may be held within the bracket 72 (e.g., couple to the frame portion 18) via any suitable technique (e.g., one or more fasteners; adhesives). In an embodiment, the lip 76 may be on one side (e.g., guest-facing side) of the display portion 16, and an additional lip (e.g., frame-shaped or ring-shaped stop or lip) may be inserted on another, opposite side (e.g., projector-facing side) of the display portion 16.

Thus, as shown, the display portion 16 may fill and/or extend across a frame opening 78 defined by the frame portion 18. Accordingly, at least some of the display portion 16 (e.g., a center region of the display portion 16) may be visible to the guest 56 in the guest area 46. Further, when the display assembly 14 is coupled to the support structure 60 (e.g., via the frame portion 18, as described herein), the display portion 16 may align with the opening 62 of the support structure 60. Indeed, the display assembly 14 (including the display portion 16 and the frame portion 18), the opening 62 of the support structure 60, and the laser projector 12 may be coaxial along a shared axis 80 (e.g., extending along the axial axis 20; parallel to the axial axis 20). Thus, the beams of light 52 from the laser projector 12 may reach the display portion 16 and may create the images on the display portion 16 for visualization by the guest 56 in the guest area 46.

It is presently recognized that it may be desirable to position the laser projector 12 to be accessible (e.g., for maintenance, such as inspection, repair, and/or replacement operations), as well as to limit ambient lighting between the laser projector 12 and the display portion 16. As such, the laser projector 12 may be coupled (e.g., mounted, fastened, adhered) to a laser support structure 82, which may be an additional decorative and/or structural wall in the entertainment venue 58. The support structure 60 and the laser support structure 82 may be coupled (e.g., mounted, fastened) together and fixed relative to one another, or the support structure 60 and the laser support structure 82 may be movable relative to one another (e.g., physically separate; the laser support structure 82 is supported on rollers, such as lockable wheels). In any case, the support structure 60 and the laser support structure 82 may be considered to form a structural assembly or wall assembly.

Additionally, a light shield 84 (e.g., tube; support ring; frame-shaped or ring-shaped structure) may extend between the laser support structure 82 (or at least from a light outlet of the laser projector 12) to the first support surface 64 of the support structure 60. The light shield 84 may be designed to block ambient light from and/or block reflections within a light path between the laser projector 12 and the support structure 60). Thus, the light shield 84 may include and/or be formed with an opaque material and/or a flat black material. For example, the light shield 84 may include a ring body formed of any suitable material and having any suitable properties (e.g., plastic material that is transparent). Further, the ring body may include a radially inner surface (e.g., exposed to and/or facing the light path), and the radially inner surface may include an opaque material, such as an opaque lining and/or a flat black paint. It should be appreciated that the light shield 84 may have any suitable geometry (e.g., cross-sectional shape, such as taken in a plane orthogonal to the axial axis 20 and/or another plane orthogonal to the lateral axis 22). For example, the light shield 84 may include a curved, circular, rectangular, square, or any other suitable cross-sectional shape taken in the plane orthogonal to the axial axis 20). Further, the light shield 84 may have a variable cross-sectional shape taken in the plane orthogonal to the axial axis 20, such as a first shape (e.g., rectangular) proximate to the laser projector 12 that transitions to a second shape (e.g., round) proximate to the support structure 60. For example, the light shield 84 may include a curved, a linear, an axially-extending, a tapered, and/or any other suitable cross-sectional shape taken in the another plane orthogonal to the lateral axis 22. For example, in the cross-sectional view of FIG. 3, the light shield 84 may include walls that taper between the laser projector 12 and the support structure 60 (e.g., the walls are angled relative to the axial axis 20; a respective value of a lateral and/or vertical dimension measured across the light shield 84 proximate to the laser projector 12 is different than a respective value of the lateral and/or vertical dimension measured across the light shield 84 proximate to the support structure 60). Indeed, it should be appreciated that the light shield 84, the opening 62, other structures, passages, and so forth described herein may have any suitable geometry (e.g., cross-sectional shapes, angles, and so forth).

In an embodiment, a gap 86 (e.g., space) between the support structure 60 and the laser support structure 82 may also be enclosed (e.g., at least during operation of the laser projection system 10; by a cover, such as an additional wall portion, fabric, or other opaque material) to further block ambient light from the light path between the laser projector 12 and the support structure 60. In this way, the control system 30 may control the laser projector 12 to project the beams of light 52 to create the images on the display portion 16 for visualization by the guest 56 in the guest area 46, wherein the images are clear and of high quality as the images are not adversely impacted by ambient light between the laser projector 12 and the display portion 16. Further, as described at least with respect to FIGS. 1 and 2, the display portion 16 may include various characteristics (e.g., the display portion 16 may include the coated treated tempered glass) such that the images are not adversely impacted by the banding effect.

While FIG. 3 illustrates one laser projector 12 and one display assembly 14 to facilitate discussion, it should be appreciated that the laser projection system 10 may include multiple laser projectors 12 and multiple display assemblies 14 (e.g., one laser projector 12 per display assembly 14, with 1, 2, 3, 4, 5, 6, 7, 8, or more laser projectors 12 and display assemblies 14 present in the attraction and/or controlled by the control system 30). For example, one laser projector 12, one display assembly 14, one light shield 84, and one opening 62 may be considered to form one laser projection unit 88 (e.g., laser projection assembly) that is coupled to and/or provided between the support structure 60 and the laser support structure 82. However, the entertainment venue 58 may include multiple laser projection units 88 distributed (e.g., spaced apart) in any suitable manner, such as along the lateral axis 22 and/or the vertical axis 24 of the support structure 60 and the laser support structure 82. Certain features, such as a respective opening 62 and/or a respective light shield 84 that are provided for each of the multiple laser projection units 88 may block cross-lighting between the multiple laser projection units 88 and may enable separate, clear images to be projected from a respective laser projector 12 for presentation on a respective display portion 16 of a respective display assembly 14. Thus, from a perspective of the guest 56 in the guest area 46, the guest 56 may view multiple images (e.g., same or different images) on multiple separate display assemblies 14 (e.g., on the multiple separate display portions 16 of the multiple separate display assemblies 14) that appear at multiple spaced apart locations of the support structure 60.

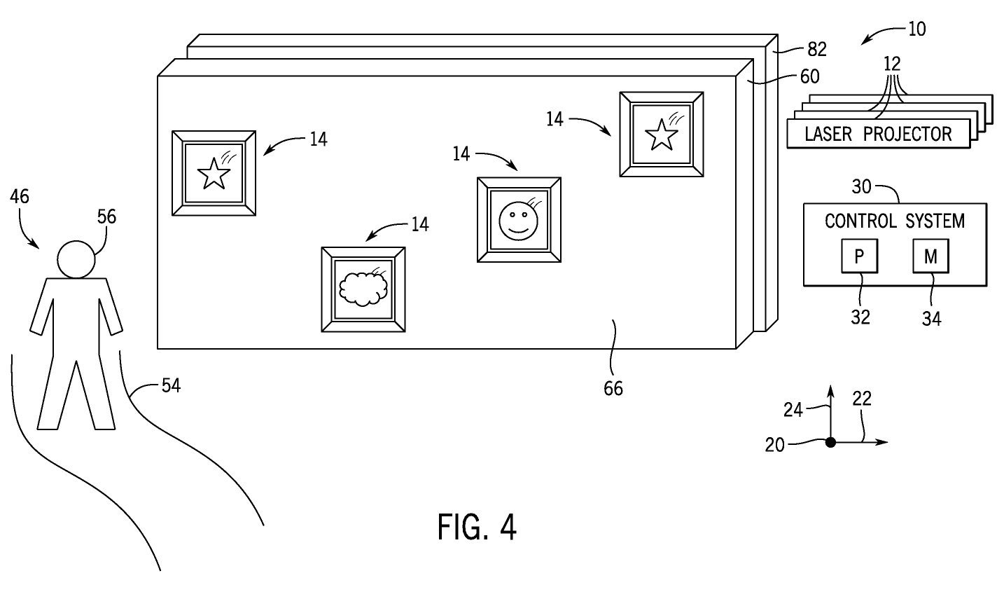

FIG. 4 is a front perspective view of the laser projection system 10, including the support structure 60 and multiple display assemblies 14 mounted to the support structure 60, in accordance with an embodiment of the present disclosure. As described herein, the laser projection system 10 may also include multiple laser projectors 12, such as one laser projector 12 per display assembly 14. To facilitate discussion, in FIG. 4, the laser projection system 10 is shown to include four laser projectors 12 and four display assemblies 14. However, it should be appreciated that the laser projection system 10 may include one, two, three, four, five, six, seven, eight, or more laser projectors 12 and display assemblies 14 present in the attraction and/or controlled by the control system 30.

In an embodiment, the multiple laser projectors 12 may be supported on the laser support structure 82. In FIG. 4, the multiple laser projectors 12 are shown schematically in block form as each laser projector 12 of the multiple laser projectors 12 is mounted rearwardly of its respective display assembly 14 (e.g., behind its respective display assembly 14 along the axial axis 20). In an embodiment, each laser projector 12 of the multiple laser projectors 12 is not visible from a perspective of the guest 56 in the guest area 46 (e.g., when traveling along the path 54; when viewing the second support surface 66 of the support structure 60). Indeed, from the perspective of the guest 56 in the guest area 46, the guest 56 may view the multiple display assemblies 14, which may be distributed (e.g., spaced apart) in any suitable manner, such as along the lateral axis 22 and/or the vertical axis 24 of the support structure 60. Thus, from the perspective of the guest 56 in the guest area 46, the guest 56 may view multiple images (e.g., same or different images) on the multiple separate display assemblies 14 that appear at multiple spaced apart locations of the support structure 60.

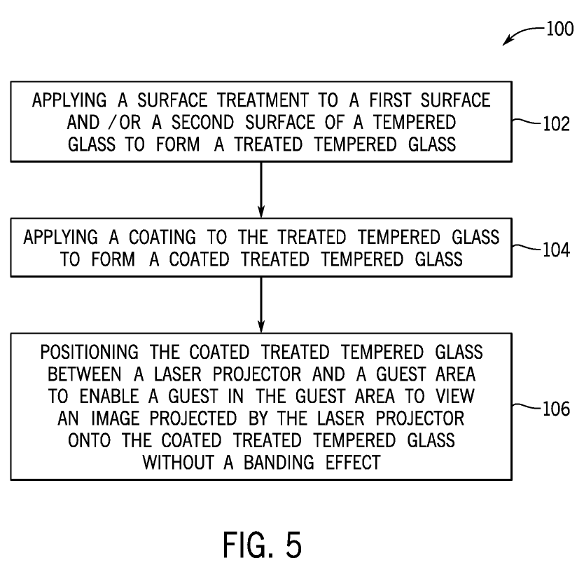

FIG. 5 is a flow diagram of a method 100 of manufacturing a laser projection system, such as the laser projection system 10 of FIGS. 1-4, in accordance with an embodiment of the present disclosure. One or more blocks of the method 100 may be performed by a control system (e.g., the control system 30 of FIGS. 1-4). Moreover, although the method 100 is described as including certain blocks performed in a particular order, it should be understood that the blocks of the method 100 may be performed in any suitable order, that certain blocks may be omitted, and/or that certain blocks may be added.

In block 102, the method 100 may include applying a surface treatment to a first surface and/or a second surface of a tempered glass to form a treated tempered glass. As an example, the surface treatment may include an abrasive blasting treatment (e.g., a sand blasting treatment) applied to the tempered glass. As an example, the surface treatment may include a film applied (e.g., adhered) to the tempered glass. The first surface and the second surface may be on opposite sides (e.g., a first side, such as a laser-facing side, and a second side, such as a guest-facing side) of the tempered glass. At least in the case of the abrasive blasting treatment, it should be appreciated that the surface treatment may be integrated into and/or part of the tempered glass (e.g., extend an axial distance from the first surface and/or the second surface into the tempered glass). As noted herein, together, the tempered glass and the surface treatment may be considered to form the treated tempered glass.

In block 104, the method 100 may include applying a coating to the treated tempered glass. In an embodiment, the coating may be applied to the second surface of the treated tempered glass. The coating may be a projection paint, a projection film, or any other type of coating that enables display of images. The coating may be a rear projection coating that enables the images to pass through the coating and to be visible from a guest area. As noted herein, together, the tempered glass, the surface treatment layers, and the coating may be considered to form the coated treated tempered glass. While the coating is described as being applied to the second surface, it should be appreciated that the coating may additionally or alternatively be applied to the first surface of the treated tempered glass (e.g., on the first surface instead of the second surface; on both the first surface and the second surface as separate layers or coatings).

In block 106, the method 100 may include positioning the coated treated tempered glass between a laser projector and the guest area to enable a guest in the guest area to view an image projected by the laser projector onto the coated treated tempered glass without a banding effect. In an embodiment, the coated treated tempered glass may be considered to form a display portion, and the display portion may be coupled to a frame portion to form a display assembly. In an embodiment, the display assembly may be coupled to a support structure such that the display portion aligns with an opening formed through the support structure. Additionally, the laser projector may be positioned to align with and to project beams of light through the opening formed through the support structure and onto the display portion that aligns with the opening formed through the support structure. For example, the laser projector may be coupled to a laser support structure that is spaced apart from the support structure, and a light shield may extend at least from an outlet of the laser projector to the support structure to block ambient light. The method 100 may be implemented with multiple pieces of tempered glass to form multiple pieces of coated treated tempered glass, and further to position each piece of the multiple pieces of coated treated tempered glass between a respective laser projector and the guest area. In this way, the guest in the guest area may view multiple images (e.g., same or different images; coordinated images) on the multiple pieces of coated treated tempered glass.

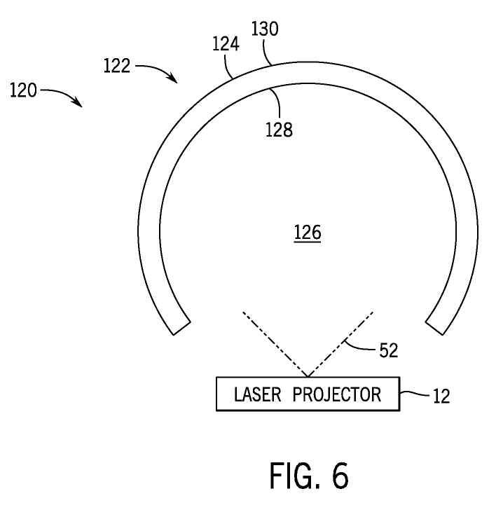

FIG. 6 illustrates a laser projection system 120 including a display assembly 122 with a curved display portion 124, in accordance with an embodiment of the present disclosure. The curved display portion 124 may include a tempered glass that is formed into a spherical shape (e.g., a partial spherical shape, a spherical shape with a bottom portion removed and/or open). The curved display portion 124 may be hollow, and the laser projector 12 may be positioned to project the beams of light 52 into a hollow space 126 (e.g., hollow cavity; interior cavity; recess) of the curved display portion 124.

In an embodiment, the curved display portion 124 may include a surface treatment to the tempered glass. As an example, the surface treatment may include an abrasive blasting treatment (e.g., a sand blasting treatment) applied to the tempered glass. As an example, the surface treatment may include a film applied (e.g., adhered) to the tempered glass. In an embodiment, the surface treatment to the tempered glass may include the surface treatment to a first surface 128 of the tempered glass and/or a second surface 130 of the tempered glass, wherein the first surface 128 is a radially-inner surface that faces toward the laser projector and the second surface 130 is a radially-outer surface that faces toward a guest area (e.g., a guest viewing area). The surface treatment may affect, such as clean and/or smooth, the first surface 128 of the tempered glass and/or the second surface 130 of the tempered glass. To facilitate discussion, after the tempered glass is subjected to the surface treatment, the tempered glass may be referred to herein as a treated tempered glass (e.g., a curved treated tempered glass).

In an embodiment, a coating may be applied to the treated tempered glass. In an embodiment, the coating may be applied to the second surface 130 of the treated tempered glass. The coating may be a projection paint, a projection film, or any other type of coating that enables display of images. The coating may be a rear projection coating that enables the images to pass through the coating and to be visible from the guest area. To facilitate discussion, after application of the coating to the treated tempered glass, the tempered glass may be referred to herein as a coated treated tempered glass (e.g., a curved coated treated tempered glass). While the coating is described as being applied to the second surface 130, it should be appreciated that the coating may additionally or alternatively be applied to the first surface 128 of the treated tempered glass (e.g., on the first surface 128 instead of the second surface 130; on both the first surface 128 and the second surface 130 as separate layers or coatings).

As shown, the laser projector 12 may project the beams of light 52 into the hollow space 126 of the curved display portion 124. The beams of light 52 may form images on the curved display portion 124, wherein the images are visible from the guest area external to the display assembly 122 (e.g., surrounding the display assembly 122). In an embodiment, the coated treated tempered glass may also provide a visual effect of the images appearing on the second surface 130 (e.g., the images appearing to be displayed on or present on the second surface 130; so as to appear to be proximate to the guest area, rather than recessed within the curved display portion 124 or distant from the guest area). The laser projection system 20 may include multiple laser projectors 12 and multiple curved display portions 124, such as to project and display multiple images in a coordinated manner.

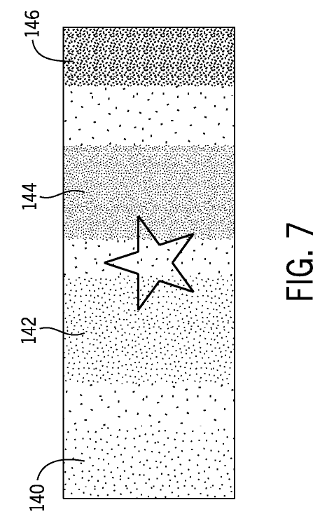

FIG. 7 illustrates an example of undesirable visual effects, such as a banding effect, that may occur without specific techniques disclosed herein (e.g., without specific surface treatments and/or coatings; without specific arrangement of the one or more laser projectors and the tempered glass). For example, projection of images by one or more laser projectors onto a display that includes a tempered glass without the techniques disclosed herein may result in the undesirable visual effects. For example, as shown in FIG. 7, the banding effect may result in bands of color that extend across the display and that are visually perceptible from a guest area (e.g., the bands of color may include a yellow band 140, a red band 142, a blue band 144, and/or a green band 146; one or more bands of color visible to a human eye, such as a first band that appears to be a first color such as yellow, which transitions to a second band that appears to be a second color such as red, which transitions to a third band that appears to be a third color such as blue, and so forth; differently colored zones; differently colored vertical bands; the one or more bands of color may be separated by gradient sections that blend adjacent bands of color and/or appear lighter in color; however, and overall impression or visual representation of banding may be visually perceptible from a guest area). In certain cases, at least some features (e.g., outlines, black and white lines) of the images (e.g., projected and/or intended images) may be visible on the display, but may be overlaid by and/or distorted by the bands of color. As set forth herein, present embodiments block this banding effect (e.g., prevent, eliminate, and/or reduce to be imperceptible to the human eye), and thus, present images in a more clear, realistic manner (e.g., without this banding effect). As such, present embodiments provide an immersive entertainment experience.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. For example, the coating may be applied to the first surface and/or the second surface of the display portion. As another example, the surface treatment may include the abrasive blasting treatment and the film, such as the abrasive blasting treatment to one surface of the tempered glass and the film applied to another surface of the tempered glass. It should be appreciated that any features shown and described with reference to FIGS. 1-6 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A laser projection system, comprising:
a laser projector configured to project an image; and
a display comprising tempered glass, wherein the tempered glass comprises a first surface that faces toward the laser projector and a second surface that faces toward a guest area, and the first surface and the second surface comprise a surface treatment, wherein the image is projected by the laser projector onto the first surface through the second surface, and wherein the image is viewable from the guest area without a banding effect.

2. The laser projection system of claim 1, wherein the first surface and the second surface comprise a planar surface.

3. The laser projection system of claim 1, wherein the surface treatment comprises an abrasive blasting treatment.

4. The laser projection system of claim 3, wherein the abrasive blasting treatment comprises a sand blasting treatment.

5. The laser projection system of claim 1, wherein the display comprises a coating layer applied to the second surface of the tempered glass, the first surface of the tempered glass, or both.

6. The laser projection system of claim 1, wherein the display provides a visual effect of the image appearing on the second surface of the tempered glass from the guest area.

7. The laser projection system of claim 1, comprising a frame peripherally surrounding the display.

8. The laser projection system of claim 7, wherein the display and the frame form a display assembly, and the display assembly is coupled to a wall.

9. The laser projection system of claim 8, wherein the wall comprises an opening, and the display assembly is coupled to the wall to align the display with the opening.

10. The laser projection system of claim 9, wherein the laser projector is positioned on an opposite side of the wall relative to the display assembly.

11. The laser projection system of claim 10, wherein the laser projector is supported on an additional wall that is separated from the wall by a gap, and the laser projection system comprises a light shield that extends across the gap to block ambient light between the laser projector and the opening of the wall.

12. The laser projection system of claim 1, comprising:
a processing system comprising one or more processors; and
memory storing instructions that are executable by the processing system to cause the processing system to instruct the laser projector to project the image:
in coordination with a show;
in coordination with movement of a ride vehicle;
in coordination with one or more additional laser projectors;
in response to a presence of one or more guests in the guest area; or
any combination thereof.

13. A method of manufacturing a laser projection system, the method comprising:
applying a surface treatment to a first surface and a second surface of a tempered glass to form a treated tempered glass;
applying a coating to the treated tempered glass to form a coated treated tempered glass; and
positioning the coated treated tempered glass between a laser projector and a guest area wherein the image is projected by the laser projector onto the coated treated tempered glass, and wherein the image is viewable from the guest area without a banding effect.

14. The method of claim 13, wherein the surface treatment comprises an abrasive blasting treatment.

15. The method of claim 13, comprising positioning a frame peripherally around the coated treated tempered glass to form a display assembly.

16. The method of claim 15, comprising coupling the display assembly to a wall such that the coated treated tempered glass is aligned with an opening formed in the wall.

17. The method of claim 16, comprising positioning the laser projector on an opposite side of the wall relative to the display assembly.

18. The method of claim 17, comprising:
supporting the laser projector on an additional wall that is separated from the wall by a gap; and
positioning a light shield across the gap to block ambient light between the laser projector and the opening formed in the wall.

19. A laser projection system, comprising:
a wall assembly comprising a first support structure and a second support structure separated from one another by a gap;
a laser projector supported on the first support structure and configured to project an image onto a display of a display assembly; and
the display assembly supported on the second support structure, wherein the display assembly comprises:
the display comprising tempered glass, wherein the tempered glass comprises a first surface that faces toward the laser projector and a second surface that faces toward a guest area, the first surface and the second surface comprise a surface treatment, and at least one of the first surface or the second surface comprises a coating; and
a frame surrounding the display, wherein at least a portion of the frame is positioned in an opening that extends through the second support structure.

20. The laser projections system of claim 19, comprising:
an additional laser projector supported on the first support structure and configured to project an additional image onto an additional display of an additional display assembly; and
the additional display assembly supported on the second support structure, wherein the display assembly comprises:
the additional display; and
an additional frame surrounding the additional display, wherein at least a respective portion of the additional frame is positioned in an additional opening that extends through the second support structure.
